(19) United States
(12) Patent Application Publication
(10) Pub. No.: US 2015/0196055 A1
(43) Pub. Date: Jul. 16, 2015

(54) ELECTRONIC CIGARETTE

(71) Applicant: KIMREE HI-TECH INC., Tortola (VG)

(72) Inventor: Qiuming Liu, Huizhou City (CN)

(21) Appl. No.: 14/412,383

(22) PCT Filed: Apr. 15, 2013
(86) PCT No.: PCT/CN2013/074216

§ 371 Date: Dec. 31, 2014

(51) Int. Cl. A24F 47/00; H05B 3/03

(52) U.S. Cl. CPC A24F 47/008; H05B 3/03

(57) ABSTRACT

An electronic cigarette (200) includes a power assembly (40) and a first atomization assembly (20). The first atomization assembly includes (20) a first atomization device (210), a first mouthpiece cover (260) and a first connector (280) which are respectively disposed at two ends of the first atomization device (210). The power assembly (40) includes a power rod (410), a battery (430) disposed in the power rod (410) and a first connecting end (480) detachably and securely connected with the first connector (280). The electronic cigarette further includes a second atomization assembly (60). The power assembly (40) further includes a second connecting end (490) detachably and securely connected with the second atomization assembly (60). The electronic cigarette (100), by detachably disposing two atomization assembly (20,60) at the two ends of the power assembly (40), allows users to smoke at any one end of the electronic cigarette (100) and may use the other end to charge while use one end of the electronic cigarette smoking, convenient to use.

### FIELD OF THE INVENTION

The present invention relates to a simulation of smoking, especially to an electronic cigarette.

### BACKGROUND OF THE INVENTION

The concept “Smoking is harmful to health” gradually comes into people's hearts, but for most smokers, it is still very difficult to quit smoking Therefore, various tobacco substitutes came into being. As a substitute of tobacco, electronic cigarettes can simulate smoking process and provide realistic smoking experience for the users, and free of tar, nicotine and other harmful substances, so welcomed by more and more smokers. The current electronic cigarette usually includes an atomization assembly and a power assembly. The atomization assembly includes an atomization device, a mouthpiece cover and a first connector which are locating at two ends of the atomization device. The power assembly includes a battery and a second connector. By engaging between the first connector and the second connector, makes the atomization assembly and a battery rod to be connected together. However, current electronic cigarette only provides an atomization assembly, and one end of the battery rod opposite to the second connector is always sealed. When need to charge the electronic cigarette, the atomization assembly firstly should be removed, then the battery rod is connected to charging device to be charged. Therefore, users can only use one end of the electronic cigarette disposed with an atomizer to smoke, and cannot charge the electronic cigarette while smoking Thus, the current electronic cigarette is not convenient to use, and unable to meet the market demand for personalized needs.

### SUMMARY OF THE INVENTION

The objective of the present invention is to provide an electronic cigarette which is convenient to use, and allows users to smoke the electronic cigarette at any end and may use the other end to charge while use one end of the electronic cigarette smoking

To achieve the aforementioned objective, the present invention provides an electronic cigarette, including a power assembly and a first atomization assembly. The first atomization assembly includes a first atomization device, a first mouthpiece cover and a first connector which are respectively disposed at two ends of the first atomization device. The power assembly includes a power rod, a battery disposed in the power rod and a first connecting end detachably and securely connected with the first connector. The electronic cigarette further includes a second atomization assembly. The power assembly further includes a second connecting end detachably and securely connected with the second atomization assembly.

Furthermore, the second atomization assembly includes a second atomization device, a second mouthpiece cover and a second connector which are respectively disposed at two ends of the second atomization device, the second connector is detachably connected with a second connecting end of the power assembly.

Furthermore, the first atomization device includes a hollow long cylindrical atomization sleeve, a liquid-storage cotton coaxially disposed in the atomization sleeve, a liquid-guiding cotton coaxially disposed in the liquid-storage cotton and abutting with the liquid-storage cotton, a fiberglass tube coaxially disposed with the atomization sleeve and an outer wall thereof abutting with the liquid-guiding cotton, and an atomizer disposed in the atomization sleeve.

Furthermore, one end of the atomization sleeve engages with the first mouthpiece cover, and the other end disposes the first connector.

Furthermore, the liquid-storage cotton is hollow long cylindrical, and two ends are spaced from two ends of the atomization sleeve by a predetermined distance.

Furthermore, one end of the liquid-guiding cotton away from the first mouthpiece cover is aligned with a corresponding end of the liquid-storage cotton, and the other end locates in the liquid-storage cotton.

Furthermore, one end of the fiberglass tube away from the first mouthpiece cover is aligned with the corresponding end of the liquid-storage cotton, and the other end stretches to a sealing ring.

Furthermore, the atomizer comprises an atomization seat, a fiberglass wire and a heating wire; the atomization seat comprises an annular sidewall and a fixing column coaxially disposed from a center of the atomization seat; the annular sidewall uses an outer wall to tensioningly fit with the atomization sleeve; the fixing column stretches in the fiberglass tube, and coaxially disposes an air vent; on the atomization seat disposes through hole for conductive wires passing through; the heating wire winds on the fiberglass wire.

Furthermore, the fiberglass wire passes through the fiberglass tube, the heating wire winds on the fiberglass wire; after power on, the heating wire heats and atomizes the e-liquid guided by the liquid-guiding cotton to aerosol for users smoking

Furthermore, an internal of first atomization device near the mouthpiece cover disposes a sealing ring; the sealing ring uses an outer wall to tensioningly fit with an inner wall of the atomization sleeve.

Furthermore, the liquid-storage cotton and the liquid-guiding cotton are disposed between the atomization seat and the sealing ring, and the liquid-storage cotton, the liquid-guiding cotton and the fiberglass tube are all abutted with the atomization seat.

Furthermore, the first connector includes a first connecting piece, a first upper electrode disposed in a center of the first connecting piece and a first insulation sleeve disposed between the first connecting piece and the first upper electrode to insulate and isolate the first connecting piece and the first upper electrode; the conductive wires connecting with two ends of the heating wire pass through the through hole of the atomization seat and electrically connect with the first connecting piece and the first upper electrode respectively.

Furthermore, the first mouthpiece cover is cylindrical, and defines a through suction hole operable for users smoking the electronic cigarette; an outer wall of the first mouthpiece cover interferingly fits with an inner wall of the atomization sleeve; one end of the first mouthpiece cover extends outward to form a flange abutting with an end portion of the atomization sleeve.

Furthermore, the first connecting end includes a first connecting seat which uses an outer wall thereof to tensioningly fit with an inner wall of the power rod, a first lower electrode disposed in a center of the first connecting seat, and a first insulation ring disposed between the first connecting seat and the first lower electrode to insulate and isolate the first connecting seat and the first lower electrode; when the first connector of the first atomization assembly and the first connecting end of the power assembly are installed together, the first connecting piece and the first connecting seat are electrically connected correspondingly, and the first upper electrode and the first lower electrode are electrically connected; the first connecting seat and the first lower electrode are electrically connected with the battery respectively by a first control circuit board.

Furthermore, the second connecting end includes a second connecting seat which uses an outer wall to tensioningly fit with the inner wall of the power rod, a second lower electrode disposed in a center of the second connecting seat, and a second insulation ring disposed between the second connecting seat and the second lower electrode to insulate and isolate the second connecting seat, and a second insulation ring; the second connecting seat and the second lower electrode are electrically connected with the battery respectively by a second control circuit board.

Furthermore, the first control circuit board is fixed in the power rod by a first fixing seat, and locates between the first connecting end and the battery. The second control circuit board is fixed in the power rod by a second fixing seat, and locates between the second connecting end and the battery.

Furthermore, a structure of the second atomization assembly is the same to the structure of the first atomization assembly; the first connecting end and the second connecting end of the power assembly are of the same structure.

By adopting the aforementioned technical solutions, the electronic cigarette of the present invention has the following advantages: by detachably disposing two atomization assembly at the two ends of the power assembly allows users to smoke the electronic cigarette at any one end and may use the other end to charge while use one end of the electronic cigarette smoking, convenient to use and better meets market demands for personalized needs.

Embodiments of the present invention will be further described in detail in the following drawings.

### BRIEF DESCRIPTION OF THE DRAWINGS

FIG. 1 is a perspective, schematic view of an electronic cigarette according to an embodiment of the present invention.

FIG. 2 is an enlarged cross-sectional view of a first atomization assembly of the electronic cigarette according to the embodiment of the present invention.

FIG. 3 is an enlarged cross-sectional view of a power assembly of the electronic cigarette according to the embodiment of the present invention.

FIG. 4 is an enlarged cross-sectional view of a second atomization assembly of the electronic cigarette according to the embodiment of the present invention.

### DETAILED DESCRIPTION OF THE INVENTION

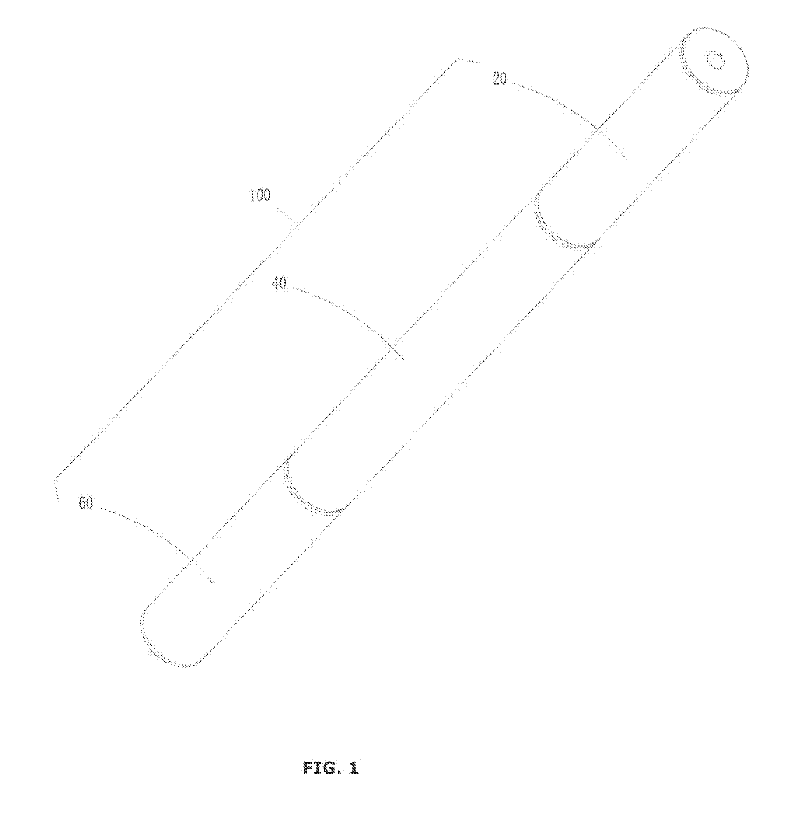

Referring to FIG. 1, an embodiment of the present invention provides an electronic cigarette 100. The electronic cigarette 100 includes a first atomization assembly 20, a power assembly 40 and a second atomization assembly 60. The first atomization assembly 20 and the second atomization assembly 60 are respectively detachably fixed at two ends of the power assembly 40. The first atomization assembly 20 and the second atomization assembly 60 may be detachably connected with the power assembly 40 by ways such as clamping, inserting, screwing or magnetic.

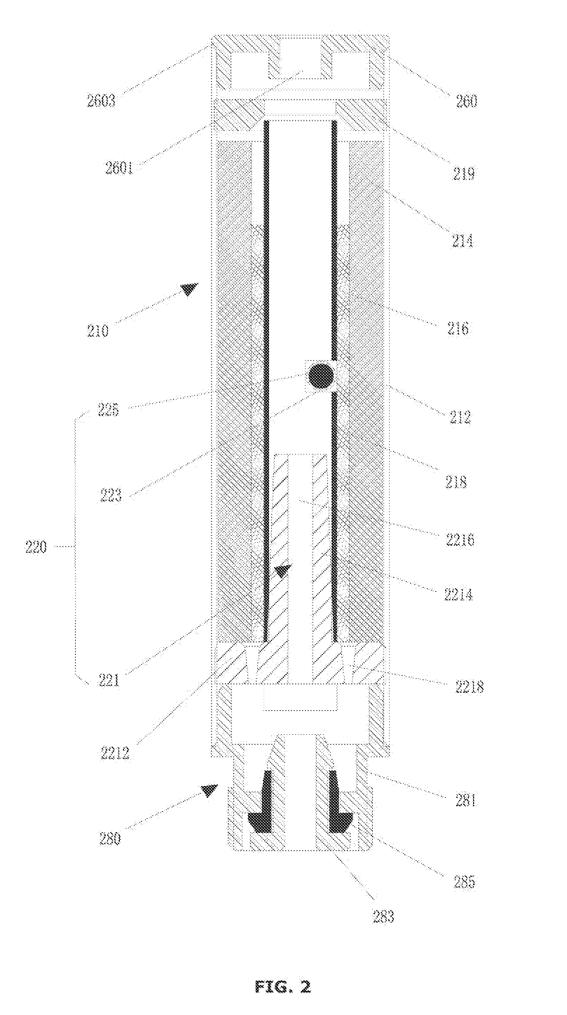

Referring to FIG. 2, the first atomization assembly 20 includes a first atomization device 210, a first mouthpiece cover 260 and a first connector 280 which are respectively disposed at two ends of the first atomization device 210.

The first atomization device 210 includes an atomization sleeve 212, a liquid-storage cotton 214, a liquid-guiding cotton 216, a fiberglass tube 218 and an atomizer 220. An internal of the first atomization device 210 near the mouthpiece cover 260 disposes a sealing ring 219. The sealing ring 219 uses an outer wall to tensioningly fit with an inner wall of the atomization sleeve 212 to achieve the purpose of sealing.

The atomization sleeve 212 is hollow long cylindrical, and one end fits with the first mouthpiece cover 260, and the other end disposes the first connector 280.

The liquid-storage cotton 214 is disposed in the atomization sleeve 212, and is used for storing e-liquid. The liquid-storage cotton 214 is also hollow long cylindrical and coaxially disposed with the atomization sleeve 212. Two ends of the liquid-storage cotton 214 and the two ends of the atomization sleeve 212 are spaced by a predetermined distance.

The liquid-guiding cotton 216 is disposed in the liquid-storage cotton 214 and abuts with the liquid-storage cotton 214 to absorb e-liquid from the liquid-storage cotton 214 and guide e-liquid in the liquid-storage cotton 214 to the atomizer 220 for heating and atomization. The liquid-guiding cotton 216 is a hollow cylinder and is coaxially disposed with the atomization sleeve 212. One end of the liquid-guiding cotton 216 away from the first mouthpiece cover 260 is aligned with a corresponding end of the liquid-storage cotton 214, and the other end locates in the liquid-storage cotton 214.

The fiberglass tube 218 is disposed in the liquid-guiding cotton 216 and is coaxially disposed with the atomization sleeve 212. An outer wall of the fiberglass tube 218 abuts with the liquid-guiding cotton 216 to support the liquid-guiding cotton 216. One end of the fiberglass tube 218 away from the first mouthpiece cover 260 is aligned with the corresponding end of the liquid-storage cotton 214, and the other end stretches to the sealing ring 219.

The atomizer 220 includes an atomization seat 221, a fiberglass wire 223 and a heating wire 225. The atomization seat 221 may be made of silicone material, and includes an annular sidewall 2212 and a fixing column 2214 coaxially disposed from a central of the atomization seat 221. The annular sidewall 2212 uses an outer wall to tensioningly fit with the atomization sleeve 212 to achieve the purpose of sealing. The liquid-storage cotton 214 and the liquid-guiding cotton 216 locate in the atomization sleeve 212, and are disposed between the atomization seat 221 and the sealing ring 310. The aligned ends of the liquid-storage cotton 214, the liquid-guiding cotton 216 and the fiberglass tube 218 abut with the atomization seat 220. The fixing column 2214 stretches in the fiberglass tube 218, and coaxially disposes an air vent 2216. On the atomization seat 221 disposes through hole 2218 for conductive wires passing through. The fiberglass wire 223 passes through the fiberglass tube 218, and the heating wire 225 winds on the fiberglass wire 223. After power on, the heating wire 225 heats and atomizes the e-liquid guided by the liquid-guiding cotton 216 to aerosol for users smoking

The first mouthpiece cover 260 is approximately cylindrical, and defines a through suction hole 2601 operable for users smoking the electronic cigarette. An outer wall of the first mouthpiece cover 260 interferingly fits with the inner wall of the atomization sleeve 212. One end of the first mouthpiece cover 260 extends outward to form a flange abutting with an end portion of the atomization sleeve 212, then achieves the sealing again for the atomization sleeve 212, effectively prevents the leakage of e-liquid.

The first connector 280 is disposed at one end of the first atomization assembly 20 away from the first mouthpiece cover 260, and is used to connect with the power assembly 40 of the electronic cigarette. The first connector 280 includes a first connecting piece 281, a first upper electrode 283 and a first insulation sleeve 285. .The first connecting piece 281 acts as a first electrode. The first upper electrode 283 is disposed in a center of the first connecting piece 281 and acts as a second electrode. The first insulation sleeve 285 is disposed between the first connecting piece 281 and the first upper electrode 283 to insulate and isolate the first connecting piece 281 and the first upper electrode 283. Conductive wires connecting the two ends of the heating wire 225 pass through the through hole of the atomization seat 221 and electrically connect with the first connecting piece 281 and the first upper electrode 283 respectively.

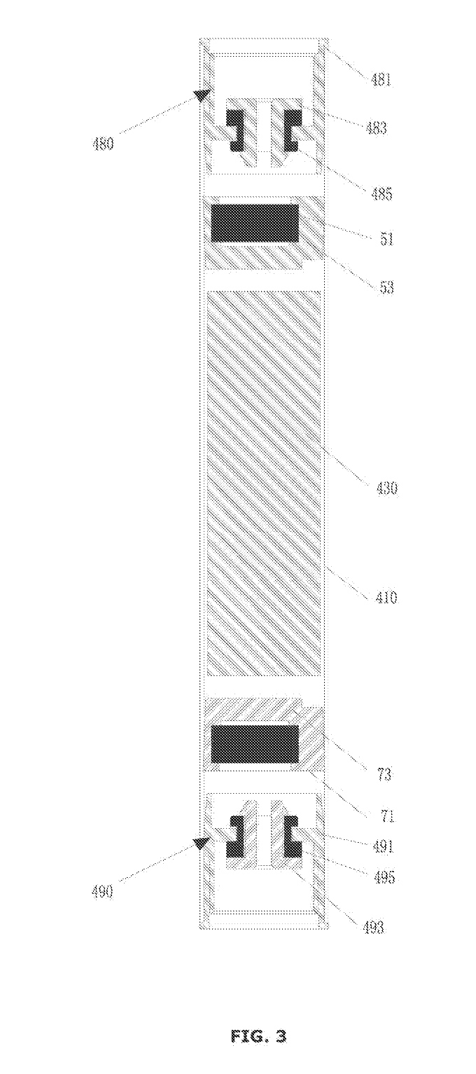

Referring to FIG. 3, the power assembly 40 includes a power rod 410, a battery 430 disposed in the power rod 410, a first connecting end 480 and a second connecting end 490 which are respectively disposed at two ends of the power rod 410.

The first connecting end 480 includes a first connecting seat 481, a first lower electrode 483 and a first insulation ring 485. The first connecting seat 481 uses an outer wall to tensioningly fit with an inner wall of the power rod 410. The first connecting seat 481 acts as a first electrode, and the first lower electrode 483 is disposed in a center of the first connecting seat 481 and acts as a second electrode. The first insulation ring 485 is disposed between the first connecting seat 481 and the first lower electrode 483 to insulate and isolate the first connecting seat 481 and the first lower electrode 483. The first connecting seat 481 and the first lower electrode 483 are electrically connected with the battery 430 respectively by a first control circuit board 51. The first control circuit board 51 is fixed in the power rod 410 by a first fixing seat 53, and locates between the first connecting end 480 and the battery 430. When the first connector 280 of the first atomization assembly 20 and the first connecting end 480 of the power assembly 40 are installed together, the first connecting piece 281 and the first connecting seat 481 are electrically connected correspondingly, and the first upper electrode 283 and the first lower electrode 482 are electrically connected. When the first connector 280 of the first atomization assembly 20 and the first connecting end 480 of the power assembly 40 are separated, the first connecting end 480 of the power assembly 40 may connect to charging wire to charge the battery 430.

The second connecting end 490 includes a second connecting seat 491, a second lower electrode 493 and a second insulation ring 495. The second connecting seat 491 uses an outer wall to tensioningly fit with the inner wall of the power rod 410. The second connecting seat 492 acts as a first electrode, and the second lower electrode 493 is disposed in a center of the second connecting seat 491 and acts as a second electrode. The second insulation ring 495 is disposed between the second connecting seat 491 and the second lower electrode 493 to insulate and isolate the second connecting seat 491 and the second lower electrode 49. The second connecting seat 491 and the second lower electrode 493 are electrically connected with the battery 430 respectively by a second control circuit board 71. The second control circuit board 71 is fixed in the power rod 410 by a second fixing seat 73, and locates between the second connecting end 490 and the battery 430.

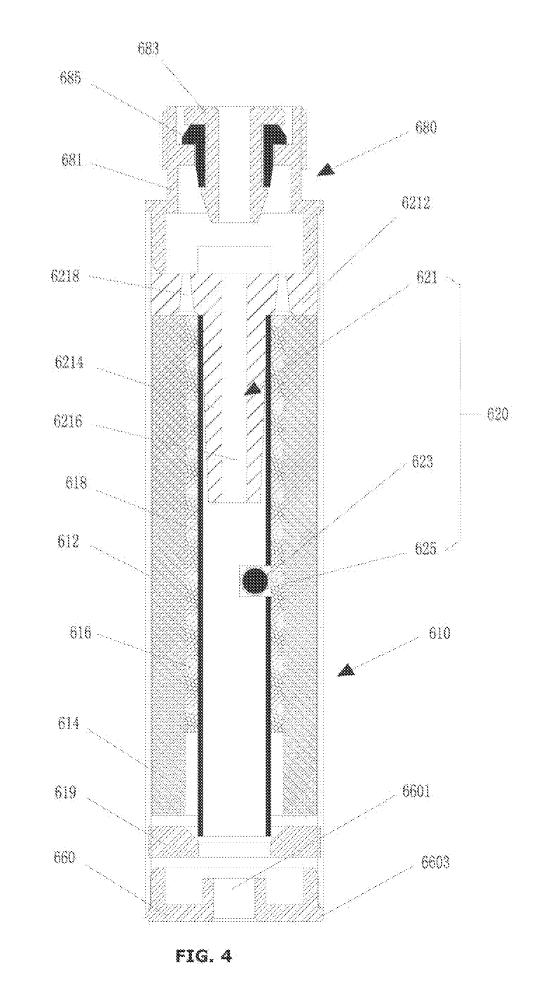

Referring to FIG. 4, the second atomization assembly 60 includes a second atomization device 610, a second mouthpiece cover 660 and a second connector 680 which are disposed at two ends of the second atomization device 610.

The second atomization device 610 includes an atomization sleeve 612, a liquid-storage cotton 614, a liquid-guiding cotton 616, a fiberglass tube 618 and an atomizer 620. An internal of second atomization device 610 near the mouthpiece cover 660 disposes a sealing ring 619. The sealing ring 619 uses an outer wall to tensioningly fit with tan inner wall of the atomization sleeve 612 to achieve the purpose of sealing.

The atomization sleeve 612 is hollow long cylindrical, and one end fits with the first mouthpiece cover 660, and the other end disposes the second connector 680.

The liquid-storage cotton 614 is disposed in the atomization sleeve 612, and is used for storing e-liquid. The liquid-storage cotton 614 is also hollow long cylindrical and coaxially disposed with the atomization sleeve 612. Two ends of the liquid-storage cotton 614 and two ends of the atomization sleeve 612 are spaced by a predetermined distance.

The liquid-guiding cotton 616 is disposed in the liquid-storage cotton 614 and abuts with the liquid-storage cotton 614 to absorb e-liquid from the liquid-storage cotton 614 and guide the e-liquid in the liquid-storage cotton 614 to the atomizer 620 for heating and atomization. The liquid-guiding cotton 616 is a hollow cylinder and is coaxially disposed with the atomization sleeve 612. One end of the liquid-guiding cotton 616 away from the second mouthpiece cover 660 is aligned with a corresponding end of the liquid-storage cotton 614, and the other end locates in the liquid-storage cotton 614.

The fiberglass tube 618 is disposed in the liquid-guiding cotton 616 and is coaxially disposed with the atomization sleeve 612. An outer wall of the fiberglass tube 618 abuts with the liquid-guiding cotton 616 to support the liquid-guiding cotton 616. One end of the fiberglass tube 618 away from the second mouthpiece cover 660 is aligned with a corresponding end of the liquid-storage cotton 614, and the other end stretches to the sealing ring 619.

The atomizer 620 includes an atomization seat 621, a fiberglass wire 623 and a heating wire 625. The atomization seat 621 may be made of silicone material, and includes an annular sidewall 6212 and a fixing column 6214 coaxially disposed from the central of the atomization seat 621. The annular sidewall 6212 uses an outer wall to tensioningly fit with the atomization sleeve 612 to achieve the purpose of sealing. The aligned ends of the liquid-storage cotton 614, the liquid-guiding cotton 616 and the fiberglass tube 618 abut with the atomization seat 620. The fixing column 6214 stretches in the fiberglass tube 618, and coaxially disposes an air vent 6216. On the atomization seat 621 disposes through hole 6218 for conductive wires passing through. The fiberglass wire 623 passes through the fiberglass tube 618, and the heating wire 625 winds on the fiberglass wire 623. After power on, the heating wire 625 heats and atomizes the e-liquid guided by the liquid-guiding cotton 616 to aerosol for users smoking.

The second mouthpiece cover 660 is approximately cylindrical, and defines a through suction hole 6601 operable for users smoking the electronic cigarette. An outer wall of the second mouthpiece cover 660 interferingly fits with the inner wall of the atomization sleeve 612. One end of the second mouthpiece cover 660 extends outward to form a flange 6603 abutting with an end portion of the atomization sleeve 612, then achieves the sealing again for the atomization sleeve 612, effectively prevents the leakage of e-liquid.

The second connector 680 is disposed at one end of the second atomization assembly 60 away from the second mouthpiece cover 660, and is used to connect with the power assembly 40 of the electronic cigarette. The second connector 680 includes a second connecting piece 681, a second upper electrode 683 and a second insulation sleeve 685. The second connecting piece 681 acts as a first electrode. The second upper electrode 683 is disposed in a center of the second connecting piece 681 and acts as a second electrode. The second insulation sleeve 685 is disposed between the second connecting piece 681 and the second upper electrode 683 to insulate and isolate the second connecting piece 681 and the second upper electrode 683. Conductive wires connecting with two ends of the heating wire 625 pass through the through hole of the atomization seat 621 and electrically connect with the second connecting piece 681 and the second upper electrode 683 respectively. When the second connector 680 of the second atomization assembly 60 and the second connecting end 490 of the power assembly 40 are installed together, the second connecting piece 681 and the second connecting seat 491 are electrically connected correspondingly, and the second upper electrode 683 and the second lower electrode 492 are electrically connected. When the second connector 680 of the second atomization assembly 60 and the second connecting end 490 of the power assembly 40 are separated, the second connecting end 490 of the power assembly 40 may connect to charging wire to charge the battery 430.

Referring to FIG. 2 and FIG. 4, in the embodiment, the structure of the second atomization assembly 60 is basically the same to the structure of the first atomization assembly 20; as another alternative embodiment, the structure of the second atomization assembly 60 may be different from the structure of the first atomization assembly 20, and may be any of the conventional feasible atomization assembly.

The electronic cigarette 100 of the embodiment of the present invention disposes two atomization assembly, as the first atomization assembly 20 and the second atomization assembly 60 which are respectively locates at the two ends of the power assembly 40. Therefore, users may use any end of the electronic cigarette 100 to smoke, convenient to use. Moreover, remove any atomization assembly 20 or 60 from one end, and make the corresponding end of the power assembly 40 to connect to charging wire, then may charge the battery 430. So, users may smoke while charge the battery 430 at the same time.

Embodiments of the present invention is shown and described in the above-mentioned. It is needed to state that embodiments and all element limitations in all embodiments may be combined in the case of no conflicts. Various improvement and modifications can be made to the embodiments by those skilled in the art without departing from the true spirit and scope of the disclosure. The scope of the present invention is defined by the appended claims and equivalents thereof

What is claimed is:

1. An electronic cigarette, comprising a power assembly and a first atomization assembly;
the first atomization assembly including a first atomization device, a first mouthpiece cover and a first connector which are respectively disposed at two ends of the first atomization device; the power assembly including a power rod, a battery disposed in the power rod and a first connecting end detachably and securely connected with the first connector; wherein the electronic cigarette further comprises a second atomization assembly; the power assembly further comprises a second connecting end which is detachably and securely connected with the second atomization assembly.

2. According to the electronic cigarette in claim 1, wherein the second atomization assembly includes a second atomization device, a second mouthpiece cover and a second connector which are respectively disposed at two ends of the second atomization device, the second connector is detachably connected with a second connecting end of the power assembly

3. According to the electronic cigarette in claim 1, wherein the first atomization device includes a hollow long cylindrical atomization sleeve, a liquid-storage cotton coaxially disposed in the atomization sleeve, a liquid-guiding cotton coaxially disposed in the liquid-storage cotton and abutting with the liquid-storage cotton, a fiberglass tube coaxially disposed with the atomization sleeve and an outer wall thereof abutting with the liquid-guiding cotton, and an atomizer disposed in the atomization sleeve.

4. According to the electronic cigarette in claim 3, wherein one end of the atomization sleeve engages with the first mouthpiece cover, and the other end disposes the first connector.

5. According to the electronic cigarette in claim 3, wherein the liquid-storage cotton is hollow long cylindrical, and two ends are spaced from two ends of the atomization sleeve by a predetermined distance.

6. According to the electronic cigarette in claim 3, wherein one end of the liquid-guiding cotton away from the first mouthpiece cover is aligned with a corresponding end of the liquid-storage cotton, and the other end locates in the liquid-storage cotton.

7. According to the electronic cigarette in claim 3, wherein one end of the fiberglass tube away from the first mouthpiece cover is aligned with the corresponding end of the liquid-storage cotton, and the other end stretches to a sealing ring.

8. According to the electronic cigarette in claim 3, wherein the atomizer comprises an atomization seat, a fiberglass wire and a heating wire; the atomization seat comprises an annular sidewall and a fixing column coaxially disposed from a center of the atomization seat; the annular sidewall uses an outer wall to tensioningly fit with the atomization sleeve; the fixing column stretches in the fiberglass tube, and coaxially disposes an air vent; on the atomization seat disposes through hole for conductive wires passing through; the heating wire winds on the fiberglass wire.

9. According to the electronic cigarette in claim 8, wherein the fiberglass wire passes through the fiberglass tube, the heating wire winds on the fiberglass wire; after power on, the heating wire heats and atomizes the e-liquid guided by the liquid-guiding cotton to aerosol for users smoking.

10. According to the electronic cigarette in claim 8, wherein an internal of first atomization device near the mouthpiece cover disposes a sealing ring; the sealing ring uses an outer wall to tensioningly fit with an inner wall of the atomization sleeve.

11. According to the electronic cigarette in claim 9, wherein the liquid-storage cotton and the liquid-guiding cotton are disposed between the atomization seat and the sealing ring, and the liquid-storage cotton, the liquid-guiding cotton and the fiberglass tube are all abutted with the atomization seat.

12. According to the electronic cigarette in claim 8, wherein the first connector includes a first connecting piece, a first upper electrode disposed in a center of the first connecting piece and a first insulation sleeve disposed between the first connecting piece and the first upper electrode to insulate and isolate the first connecting piece and the first upper electrode; the conductive wires connecting with two ends of the heating wire pass through the through hole of the atomization seat and electrically connect with the first connecting piece and the first upper electrode respectively.

13. According to the electronic cigarette in claim 3, wherein the first mouthpiece cover is cylindrical, and defines a through suction hole operable for users smoking the electronic cigarette; an outer wall of the first mouthpiece cover interferingly fits with an inner wall of the atomization sleeve; one end of the first mouthpiece cover extends outward to form a flange abutting with an end portion of the atomization sleeve.

14. According to the electronic cigarette in claim 1, wherein the first connecting end includes a first connecting seat which uses an outer wall thereof to tensioningly fit with an inner wall of the power rod, a first lower electrode disposed in a center of the first connecting seat, and a first insulation ring disposed between the first connecting seat and the first lower electrode to insulate and isolate the first connecting seat and the first lower electrode; when the first connector of the first atomization assembly and the first connecting end of the power assembly are installed together, the first connecting piece and the first connecting seat are electrically connected correspondingly, and the first upper electrode and the first lower electrode are electrically connected; the first connecting seat and the first lower electrode are electrically connected with the battery respectively by a first control circuit board.

15. According to the electronic cigarette in claim 14, wherein the second connecting end includes a second connecting seat which uses an outer wall to tensioningly fit with the inner wall of the power rod, a second lower electrode disposed in a center of the second connecting seat, and a second insulation ring disposed between the second connecting seat and the second lower electrode to insulate and isolate the second connecting seat, and a second insulation ring; the second connecting seat and the second lower electrode are electrically connected with the battery respectively by a second control circuit board.

16. According to the electronic cigarette in claim 15, wherein the first control circuit board is fixed in the power rod by a first fixing seat, and locates between the first connecting end and the battery; the second control circuit board is fixed in the power rod by a second fixing seat, and locates between the second connecting end and the battery.

17. According to the electronic cigarette in claim 1, wherein a structure of the second atomization assembly is the same to the structure of the first atomization assembly; the first connecting end and the second connecting end of the power assembly are of the same structure.
